(19) United States
(12) Patent Application Publication
(10) Pub. No.: US 2001/0003301 A1
(43) Pub. Date: Jun. 14, 2001

(54) LOW PROFILE AIR COOLED AIR COMPRESSOR AND AFTERCOOLER

(76) Inventors: WALTER E. GOETTEL, MONONGAHELA, PA (US); JULIE A. KRAWCZYK, MONROEVILLE, PA (US); ROGER DRUMMOND, HERMINIE, PA (US); DANIEL G. WAGNER, PITTSBURGH, PA (US)

Correspondence Address: JAMES RAY & ASSOCIATES, 2640 PITCAIRN ROAD, MONROEVILLE, PA, 14146

(21) Appl. No.: 09/352,974

(22) Filed: Jul. 14, 1999

Related U.S. Application Data
(63) Continuation-in-part of application No. 08/886,614, filed on Jul. 1, 1997, now abandoned.

(51) Int. Cl. F03C 2/00; F03C 4/00; F04C 15/00; F01C 21/04; F01C 21/06; F04C 27/02; F04C 29/02; F04C 29/04; F04C 2/00

(52) U.S. Cl. 165/47; 417/243

(57) ABSTRACT

An air compressor and aftercooler combination in which the aftercooler is located in front of the air compressor. The aftercooler is connected to the air compressor for receiving hot, high pressure air and for effectively cooling the same such that the temperature of the high pressure air delivered by the aftercooler approaches that of atmospheric ambient. A fan is located to draw and direct atmospheric ambient air to the compressor and to and through aftercooler for effective cooling of the high pressure air in the aftercooler, as received from the compressor.

### CROSS REFERENCE TO RELATED APPLICATION

This application is a continuation-in-part of U.S. Ser. No. 08/886,614 filed Jul. 1, 1997.

### FIELD OF INVENTION

The present invention relates generally to air compressors providing compressed, high pressure air and more particularly to an AFTERCOOLER located in front of the air compressor and in front of a fan and shroud that draws air through the aftercooler and directs the same to the compressor. The location of the aftercooler, fan and shroud provides a “short”, low profile compressor/aftercooler combination.

### BACKGROUND OF THE INVENTION

U.S. Pat. No. 5,106,270 to Goettel et al. discloses an integral compressor/aftercooler wherein air is compressed and thereby heated in the compressor. The heated air is then sent to the aftercooler to be reduced in temperature for the purpose of condensing water vapor contained in the heated air to liquid water. The liquid water is removed from the compressed air before it is used in braking systems of locomotives and railway cars connected to the locomotives.

The benefits of the Goettel et al. integral compressor/aftercooler are well known in the railroad industry. The disclosure of the Goettel et al. Patent is incorporated herein by reference.

The compressor and aftercooler shown in the Goettel et al. patent is a rather tall device, and most American made locomotives have room to accommodate the Goettel et al. compressor and aftercooler. The actual height of the Goettel et al. compressor/aftercooler is brought about by the aftercooler 4 (in the patent) being located beneath a crank shaft 13, 14, as depicted in FIG. 3 of the Goettel et al. patent, with the output of a high pressure cylinder 11 connected to the aftercooler by a pipe 39. As disclosed in the Goettel et al. patent the aftercooler is highly effective in reducing the temperature of compressed air leaving the compressor so that water vapor is condensed to liquid water for removal from a reservoir of compressed air in a locomotive.

A prominent manufacture of locomotives asked Westinghouse Air Brake Company (WABCO), the assignee of the present application, if it could make a compressor/aftercooler unit having a height of no more than 36.36 inches. WABCO makes a “short”, 36.42 inch compressor with an aftercooler that is generically covered in the above U.S. Pat. No. 5,106,270. WABCO, of course makes compressors with intercoolers and aftercoolers of different sizes, a “tall” compressor/aftercooler combination being on the order of 47.76 inches.

The above manufacturer of locomotives also specified that the aftercooler be sized to provide a certain maximum air temperature rise above ambient. This the applicants' were able to do, as shown by the graph depicted in FIG. 2 of the drawings of this application.

### SUMMARY OF THE INVENTION

Hence, some locomotives being manufactured and used do not have sufficient vertical space to contain the rather tall compressor/aftercooler combination disclosed in the above Goettel et al. patent. It has therefore been necessary to reconsider the Goettel compressor/aftercooler combination so that locomotives with less vertical room can be provided with the advantageous compressor/aftercooler combination of the Goettel et al. patent.

The present invention provides a low profile compressor/aftercooler unit by locating the aftercooler in front of the compressor, rather than beneath the compressor and its crankshaft. The aftercooler in the present invention is located also in front of a fan and shroud that directs ambient atmospheric air to the compressor for cooling the same after the ambient air passes through the aftercooler, i.e., the fan draws air through the aftercooler to provide effective cooling of hot compressed air in the aftercooler while simultaneously directing air to and past the compressor to cool the same.

It is therefore an objective to the invention to use the aftercooler concept of the above U.S. patent to Goettel et al. in a manner that substantially reduces the height of an compressor/aftercooler combination such that the combination can be accommodated in locomotives having shallow internal space.

It is another objective of the invention to place an aftercooler in front of an compressor and an air pulling fan that operates to cool the compressor.

It is another objective of the invention to draw ambient air through an aftercooler as the air is directed to the compressor without unduly heating the ambient air before it is directed to the compressor.

It is yet another objective of the invention to provide a “short crankcase” compressor for locomotives that do not have the head room necessary for a “tall” compressor/aftercooler.

### THE DRAWINGS

The objectives and advantages of the invention will be better understood from consideration of the following detailed description and the accompanying drawings in which:

FIG. 1 is a side elevation view of the aftercooler/fan/compressor combination of the invention, and

FIG. 2 is a graph showing temperature reductions of compressed air using the apparatus of the invention shown in FIG. 1. The data presented in FIG. 2 is a worse case scenario, as the RPM of the compressor is 1050 working against a pressure head of 140 psig. Ordinarily and under normal duty conditions, the RPM and pressure head are lower.

### PREFERRED EMBODIMENT

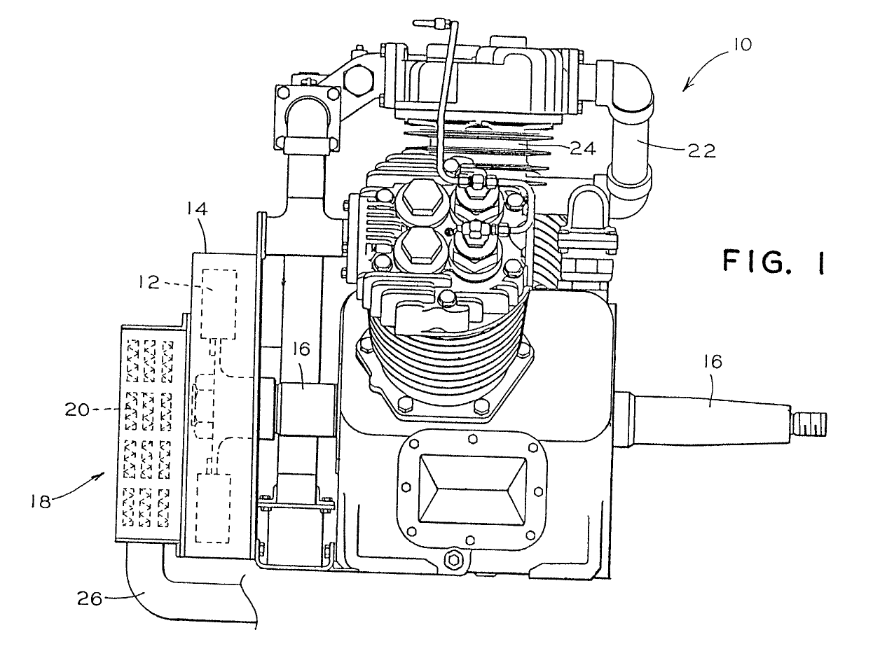

Referring now to FIG. 1 of the drawings, a low profile “short crankcase” air compressor 10 is shown in side elevation. In front of the compressor is a fan 12 and a shroud 14. The shroud can be bolted to the front of the compressor, as shown. A common shaft 16 can drive both the compressor and fan, though the invention is not limited thereto, i.e., separate drive shafts and power sources, such as electric motors can be used to separately drive the compressor and fan.

In front of fan 12 and shroud 14, and thus in front of the compressor 10 and in general alignment with shaft 16, is located an aftercooler 18. The aftercooler is shown suitably bolted to the shroud and compressor.

Aftercooler 18 includes heat exchange tubing 20 connected to a high pressure output pipe 22 of a high pressure cylinder 24 of compressor 10, said cylinder and its head having appropriate, air cooling fins. This is also true for the low pressure cylinders and heads, only one of which visible in FIG. 1. As disclosed in the above Goettel et al. patent, aftercooler 18 is effective in reducing the temperature of compressed air sent to the aftercooler tubing 20 from the compressor to a level near ambient for the purpose of condensing water vapor contained in the compressed air. The cooled, near ambient air leaves aftercooler tubing 20 via a pipe 26 for passage to a main reservoir or reservoirs of a locomotive. In this manner liquid water is formed which can be drained from the main reservoir before the compressed air is used.

As is clear from the presentation in FIG. 1, no aftercooler structure is located beneath the crankcase of compressor 10. This lowers significantly the height of the compressor/aftercooler unit. Rather, the aftercooler (18) is moved to a location in front of the compressor (10) such that the compressor/aftercooler combination is relatively low and short in overall height, and is slightly longer than the combination shown in the above Goettel et al patent. The structure of FIG. 1 can be accommodated in locomotives having the space for such a slightly longer unit but do not have the height for accomodating the unit shown in the Goettel et al. patent.

As shown in FIG. 1, aftercooler 18 can be substantially shorter than compressor 10 such that the oerall height of the combination is that of the compressor.

In the combination of FIG. 1, fan 12 performs its normal function of cooling the finned cylinders and cylinder heads of compressor 10 by drawing ambient atmospheric air through shroud 14 and directing the same to compressor 10 while simultaneously pulling ambient atmospheric air through aftercooler 18 and past its tubing 20 to cool the heated compressed air sent from the compressor to the aftercooler. Because the atmospheric air passes by tubing 20 containing heated compressed air, the atmospheric air directed through shroud 14 and to the compressor is heated somewhat by the aftercooler.

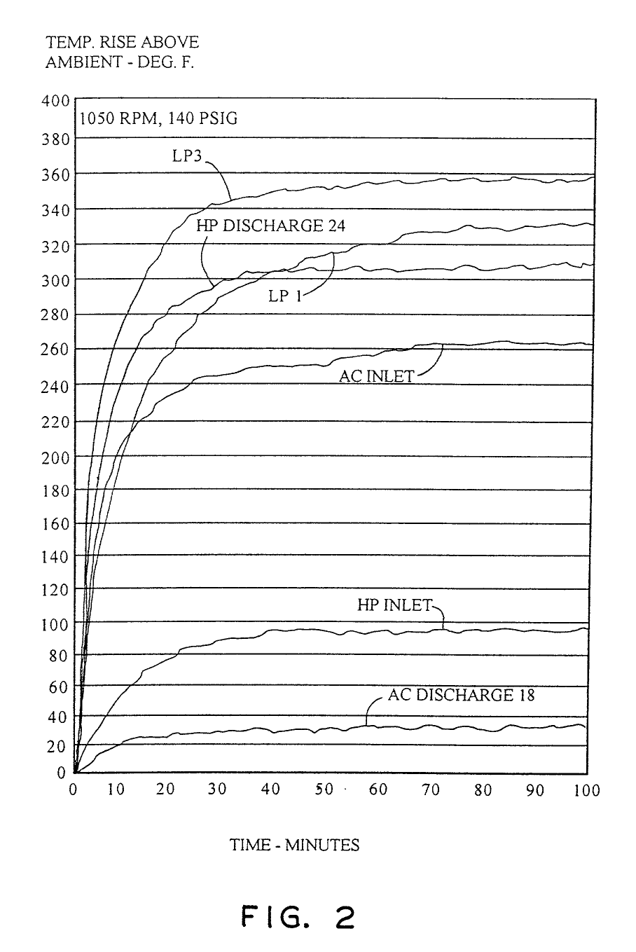

However, in tests run on the combination depicted in FIG. 1 of the drawings, fan 12 still provides sufficient and efficient cooling of compressor 10 while simultaneously providing effective cooling of the compressed air in aftercooler tubing 20. This latter function is verified by the data presented in the graph of FIG. 2. As shown, the high pressure (HP 24) discharge from compressor cylinder 24 rapidly rises to 325° F. above ambient while the aftercooler discharge (AC 18) is at a temperature of 30 to 35° F. above ambient. This is highly effective in condensing water vapor in the compressed air to liquid water for draining from systems using the compressed air.

In addition, as mentioned above, the data presented in FIG. 2 was generated under a worse case scenario, i.e., the compressor 10 was operated at a high, 1050 RPM against a substantial pressure head of 140 psig, thereby producing the high discharge temperatures shown. Any lower rotational velocity of the compressor produces compressed air at lower temperatures, and lower operating temperatures of the compressor.

The subject matter that is regarded as the present invention is set forth and distinctly presented in the following claims. It will be understood that variations, modifications and substitutions of the invention may be made by those skilled in the art without departing from the spirit and scope of the invention as set forth in the claims.

What is claimed is:

1. An air compressor for use in a locomotive and in a relatively shallow space within the locomotive in combination with an aftercooler connected to the air compressor for effectively cooling hot high pressure air produced by the compressor and directed to said aftercooler such that the temperature of such high pressure air delivered by the aftercooler approaches that of atmospheric ambient, said aftercooler being located in front of and in general horizontal alignment with the compressor such that the compressor and aftercooler have an overall height that is that of the compressor, and a fan located in general horizontal alignment with the aftercooler for drawing and directing atmospheric ambient air to the compressor and to and through said aftercooler for effective cooling of the high pressure air in the aftercooler, as received from the compressor, said fan having a height that is less than that of the compressor.

2. The combination of claim 1 wherein the compressor and fan are operated by a common power driven shaft, and said aftercooler is located in general alignment with said shaft.

3. The combination of claim 1 including a shroud located around said fan, with the aftercooler being located to receive atmospheric air drawn by the fan through said shroud.
